(19) United States
(12) Patent Application Publication
(10) Pub. No.: US 2006/0293102 A1
(43) Pub. Date: Dec. 28, 2006

(54) Wireless controller for a remote control toy with a hand-held game player function

(76) Inventor: Jeremy John Kelsey, Taichung City (TW)

Correspondence Address: John S. Egbert;Egbert Law Offices, 7th Floor, 412 Main Street, Houston, TX, 77002, US

(21) Appl. No.: 11/165,558

(22) Filed: Jun. 23, 2005

(51) Int. Cl. A63F 13/12; A63H 30/04

(52) U.S. Cl. 463/37; 463/39; 446/456

(57) ABSTRACT

The wireless controller for remote control toy with hand-held game player function includes a remote control, a video camera that is placed on the remote control toy, the image shot from the video camera being transmitted through a video signal transmitter, remote control and screen, video card, wireless receiver and hand-held game player that has game control unit. The game player component is placed on the remote control, so that a connecting end of the hand-held game player may be connected to the game player component on the remote control. The screen on the game player can be used for remote control and can show the moving image of the remote control toy, which is cost effective, and improves the product's practicability, and entertainment value.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a remote control toy, and more particularly to a wireless controller for remote control toy with hand-held game player function.

### BACKGROUND OF THE INVENTION

When controlling the regular remote control toys, such as remote control car, remote control plane and remote control boat, because the operator can see clearly within a short distance, therefore, it does not affect the accuracy of the control. However, when the location of the remote control toy is too far away, because the operator cannot see clearly, therefore, it has impact on the accuracy of the control; because of this, some people have invented a structure that combines a screen with the remote control; it mainly adds a screen and wireless receiver onto the remote control for the remote control toy, and adds a video camera and video signal transmitter on the remote control toy, and by transmitting the image that is in front of the driving toy shot by the video camera to the wireless receiver on the remote control the image is shown on the screen, therefore, the operator can operate the remote control more accurately through the assistance of image screen; except, this conventional structure still has the following problems exist in practical experience.

Because of the screen mentioned above is designed specially for this type of remote control toy, therefore, it does not have other functions, and is not compatible with other products, therefore, for most of gamers, adding the screen may be too lavish, after all, the installation of the screen costs a lot of money, and with this single-functioned device that is not even necessary (some gamer may give up using it because of the high cost), the practical value of the product and level of being favored by consumers has largely reduced.

From another point of view, many little children have remote control toys and hand-held game player (such as Nintendo). However, the hand-held game player cannot be combined with remote control of the remote control toy to serve as its screen, therefore, it has caused disadvantages such as inconvenience and cost increase.

Thus, to overcome the aforementioned problems of the prior art, it would be an advancement if the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

1. A wireless controller for remote control toy with hand-held game player function disclosed in the present invention mainly comprising a screen, video card, wireless receiver and the combination of the hand-held game player that has game control unit and remote control for the remote control toy, so that the hand-held game player mentioned above can be used as the screen for remote control, and both of them have their own functions after separation, and by so doing, it improves its function, which makes it cost effective and improves its practicability.

2. Furthermore, for playful children, the improved design of the present invention has the image function desired by combining the hand-held game player with the remote control that has game player component, which makes it more convenient to use and carry, and it is economical.

3. Moreover, this wireless controller for remote control toy with hand-held game player not just provides well accuracy; another main part is the fun experience of driving the vehicle from the driver's seat perspective.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the present invention.

FIG. 2 shows an operating view of the present invention.

FIG. 3 shows an exploded local view of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

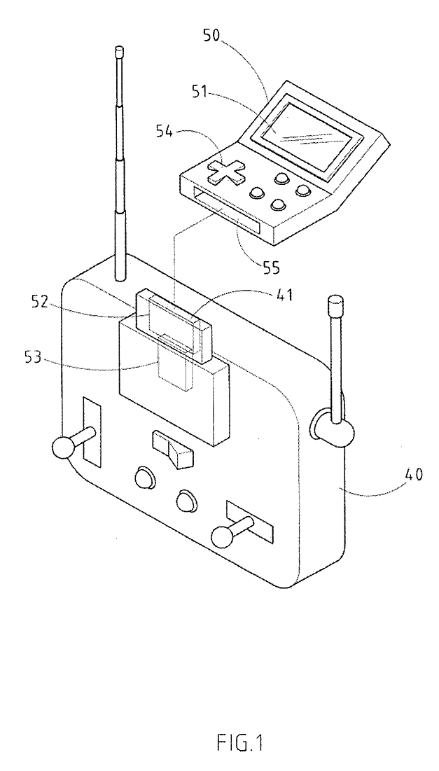

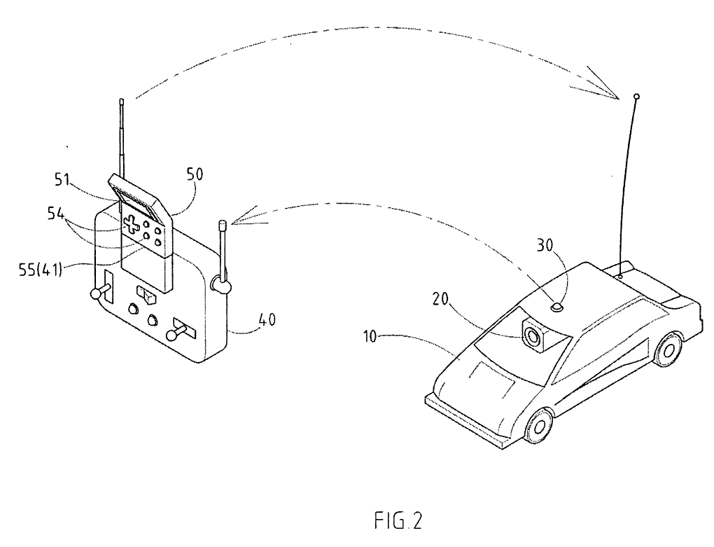

As shown in FIGS. 1-3, a wireless controller for remote control toy with hand-held game player function comprising:

a remote control toy 10, which can be remote control car, remote control airplane and remote control boat or a robot.

a video camera 20, which is pre-installed on the remote control toy 10, and is used to display the image in front of the remote control toy 10 when it is moving;

a video signal transmitter 30, which converts the image obtained by the video camera 20 mentioned above to wireless signal and transmits it out;

There is a remote control 40, which can operate the remote control toy 10 mentioned above wirelessly, and the main part of it is the same as the remote control for the remote control toy, which includes an antenna, several keys and joystick, and this part is well-known. The feature of the present invention is: a game player component 41 is placed on the remote control 40; the game player component of the embodiment is a protruding block that is located on the operating surface of the remote control, and a video card 52 and a wireless receiver 53 are placed in the game player component 41.

There is also a hand-held game player 50, which includes a screen 51 and game control unit 54, and among them, the game control unit 54 mentioned above includes some keys and joystick for the hand-held player, which of course includes the electronic circuit control inside; and the game player 50 has a connecting end 55 that can be connected to the game player component 41 on the remote control 40 mentioned above, and connects the signal from the video card 52 on the remote control to the screen 51; the connecting end 55 mentioned above can be a groove that can be connected tightly to the game player component 41 that is shaped like protruding block; moreover, the wireless receiver 53 mentioned above can receive the wireless signal transmitted from the video signal transmitter 30 of the video camera 20 mentioned above.

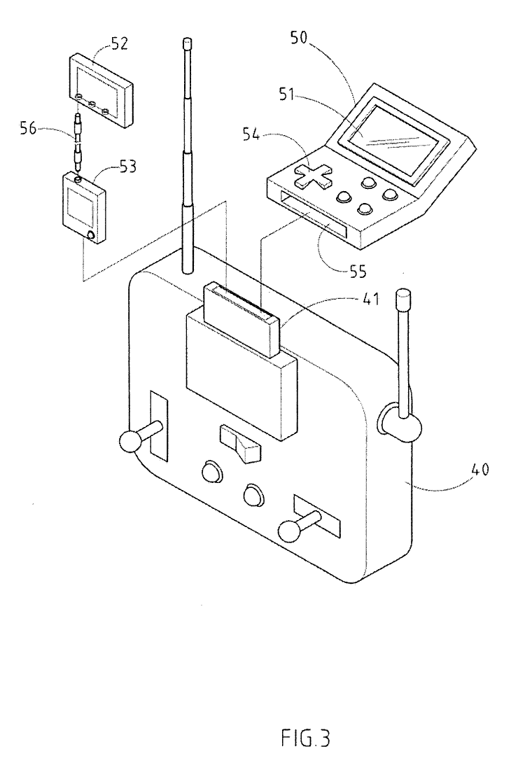

Among them, the wireless receiver 53 and video card 52 mentioned above can be built in or combined structure; the “combined” structure here is shown in FIG. 3, which is a component that is made of wireless receiver 53 and video card 52 independently (like a card) and they are connected by transmitting line 56; and the “built in” here means to include the wireless receiver 52 and video processor 52 inside the game player 50, and this type of technology is currently available, for instance: PSP (Playstation Portable) and hand-held game player are using this structure.

In addition, the frequency of the wireless receiver 53 matches the wireless signal frequency transmitted from the video signal transmitter 30 of the video camera 20 on the remote control toy 10 to achieve the purpose of signal transmission; furthermore, it can be achieved by the driving module (including soft and hardware) that adjusts frequency, and the driving module mentioned above can be placed on the hand-held game player 50.

Through the above structure and design, the operation of the present invention disclosed is explained as follows:

Under the circumstances where the hand-held game player 50 is used independently, it has the functions of regular hand-held game player 50, and it shows the moving images by the screen 51; and before the remote control 40 is connected to the game player 50 mentioned above, besides it has no image function, it has regular remote control function; and when the gamer desires to use the image function of the remote control toy 10, he/she can just connect the connecting end 55 on the hand-held game player 50 to the game player component 41 of the remote control 40, and by so doing, the wireless signal transmitted from the video signal transmitter 30 on the remote control toy 10 can be received by the wireless receiver 53 on the hand-held game player 50, and furthermore, it can be converted by the video card 52, and shows the moving images of the remote control toy 10.

1. A wireless controller for a remote control toy with a hand-held game player function, comprising:
a remote control toy;
a video camera, being pre-installed on the remote control toy and displaying an image in front of the remote control toy when moving;
a video signal transmitter, said image obtained by the video camera being converted to wireless signal and transmitted out by the transmitter;
a remote control, being in wireless control of said remote control toy, and having a game player component placed on the remote control; the game player component having a video card and a wireless receiver placed in the game player component;
a hand-held game player, being comprised of a screen and game control unit, a connecting end of the game player being connected to the game player component on the remote control, and connecting signal from the video card on the remote control to the screen; the wireless receiver receiving a wireless signal transmitted from the video signal transmitter.

2. The structure defined in claim 1, wherein an end of the hand-held game player and the game player component of the remote control are connected in shapes of a groove and a protruding block.

3. A wireless controller for a remote control toy with a hand-held game player function, comprising:
a remote control toy;
a video camera being pre-installed on the remote control toy, and displaying an image in front of the remote control toy when moving;
a video signal transmitter, the image obtained by the video camera being converted to a wireless signal and transmitted out by the signal transmitter;
a remote control, being in wireless control of the remote control toy, and having a game player component placed on the remote control; the game player component having a video card and a wireless receiver placed in the game player component;
a hand-held game player, being comprised of a screen and game control unit, the game player having a connecting end connected to the game player component on the remote control, signal from the video card on the remote control being connected to the screen; the wireless receiver receiving the wireless signal transmitted from the video signal transmitter.

4. The structure defined in claim 3, wherein an end of the hand-held game player and the game player component of the remote control are connected in shapes of a groove a and protruding block.

5. A remote control for a remote control toy comprising: an antenna, several keys and joystick, the remote control having a game player component connected to an end of a hand-held game player for the remote control toy that has a game player function according to claim 1.
